(19) United States
(12) Patent Application Publication
(10) Pub. No.: US 2024/0421311 A1
(43) Pub. Date: Dec. 19, 2024

(54) ELECTRODE FILM ROLLED WEB, ELECTRODE, ELECTRODE LAMINATE, ELECTROCHEMICAL DEVICE, AND APPARATUS

(71) Applicant: FUJIMORI KOGYO CO., LTD., Tokyo (JP)

(72) Inventors: Ayumi ANDOU, Tokyo (JP); Yasuki HIRATA, Tokyo (JP); Tsutomu HAYASHI, Tokyo (JP); Takuo YONEDA, Tokyo (JP); Mitsuru TOKURA, Tokyo (JP); Ryuichi SATOU, Tokyo (JP)

(21) Appl. No.: 18/739,327

(22) Filed: Jun. 11, 2024

(30) Foreign Application Priority Data
Jun. 15, 2023 (JP) 2023-098818

(51) Int. Cl. H01M 4/62; H01M 4/02; H01M 4/04

(52) U.S. Cl. CPC H01M 4/622; H01M 4/0404; H01M 4/625; H01M 4/626; H01M 2004/027

(57) ABSTRACT

The present invention relates to an electrode film rolled web including an adhesive layer, and a negative active material layer laminated on the adhesive layer and including a negative active material, where the adhesive layer includes a particulate conductive material and a binder, the binder contains a polyisobutylene and a polypropylene, the conductive material is at least one selected from the group consisting of a carbon material and a metal material that is not alloyed with Li, and the adhesive layer satisfies particular content ratios.

### CROSS-REFERENCE TO RELATED APPLICATIONS

This application claims the priority based on Japanese Patent Application No. 2023-098818 filed on Jun. 15, 2023, the entirety of which is incorporated herein by reference.

### BACKGROUND

### Technical Field

The present invention relates to an electrode film rolled web, an electrode, an electrode laminate, an electrochemical device, and an apparatus.

### Related Art

In recent years, the importance of secondary batteries for use as power sources has been increased. Secondary batteries have been actively researched and developed, from small batteries such as power sources for portable electronic apparatuses to medium and large batteries such as batteries for electric vehicles and household storage batteries.

Secondary batteries each have a pair of electrodes each including an active material and an electrolyte disposed between the electrodes. The pair of electrodes includes a positive electrode including a positive active material and a negative electrode including a negative active material. As these electrodes, configurations are known, which have a laminate of an active material layer including a positive active material or a negative active material, and a current collector with excellent conductivity.

The active material layer mentioned above is formed by dispersing a powdery active material and a binder in a solvent to prepare a mixture in the form of slurry, coating the current collector with the obtained mixture, and pressing the current collector with the mixture thereon. The laminate of the active material layer and the current collector is cut into a desired battery shape, and used as an electrode (see, for example, Japanese Unexamined Patent Application, First Publication No. 2019-169444).

### SUMMARY

As described above, multistage processing such as preparing the mixture, coating with the mixture, drying, and pressing is necessary in order to fabricate the electrode. For simplifying the manufacturing process for secondary batteries and reducing the manufacturing cost, there is room for contrivance in terms of material.

The same problem may be caused not only in the secondary battery but also in other electrochemical elements such as a capacitor.

The present invention has been made in view of such circumstances, and an object of the invention is to provide a novel electrode film rolled web for use as a material for an electrode. In addition, another object of the present invention is to provide an electrode and an electrode laminate for which such an electrode film rolled web is used as a material. Yet another object of the present invention to provide an electrochemical device including such an electrode laminate, and an apparatus including the electrochemical device.

The inventors have considered that if a material that has characteristics for being usable as an electrode, with sufficient mechanical strength, can be achieved without using any current collector, processes such as designing a more efficient electrochemical device and coating a current collector with a mixture as described above can be omitted. In addition, the material shaped in a film is considered to allow an electrochemical device to be easily manufactured by cutting the film (electrode film rolled web) and bonding the film to a battery element.

For solving the problems mentioned above, an aspect of the present invention includes the following aspects.

[1] An electrode film rolled web including: an adhesive layer; and a negative active material layer laminated on the adhesive layer and including a negative active material, where the adhesive layer includes a particulate conductive material and a binder, the binder contains a polyisobutylene and a polypropylene, the conductive material is at least one selected from the group consisting of a carbon material and a metal material that is not alloyed with Li, and the adhesive layer satisfies the following (A) and (B):
(A) The adhesive layer contains the conductive material in an amount of 13% by mass or more and 60% by mass or less, the polyisobutylene in an amount of 6% by mass or more and 20% by mass or less, and the polypropylene in an amount of 34% by mass or more and 75% by mass or less, based on 100% by mass in total of the conductive material and the binder.
(B) The ratio by mass between the polyisobutylene and the polypropylene is [polyisobutylene]: [polypropylene]=1:4 to 7.

[2] The electrode film rolled web according to [1], where the breaking strength determined by the following measurement method is 0.5 MPa or more.

### (Measurement Method)

The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

[3] The electrode film rolled web according to [1] or [2], where for a test piece thereof bonded under the following bonding condition 1, the normal-temperature adhesive strength in a 90° peeling test performed by the following measurement method is 0.03 N/cm or more.

### (Measurement Method)

The strength is measured when a test piece of 15 mm in width and 50 mm in length cut out from the electrode film rolled web is peeled off by 90° at a speed of 20 mm/min after bonding a surface of the adhesive layer side of the test piece onto the center of a copper foil of 15 mm in width and 60 mm in length.

The arithmetic mean value of measured values obtained by performing the same measurement three times is defined as the adhesive strength.

### (Bonding Condition 1)

Roll bonding under an environment at a pressure of 8.6 kg/cm, a speed of 1 m/min, and 25° C.

[4] The electrode film rolled web according to [3], where for a test piece thereof bonded under the following bonding condition 2, the heated adhesive strength in a 90° peeling test performed by the measurement method is 0.10 N/cm or more.

### (Bonding Condition 2)

Roll bonding under an environment at a pressure of 8.6 kg/cm, a speed of 1 m/min, and 50° C.

[5] The electrode film rolled web according to any one of [1] to [4], where the SOC-OCV value determined by the following method is 18 times or more.

### (Measurement Method)

The amount of the active material included in a test electrode prepared from the electrode film rolled web is calculated, and the theoretical capacity (mAh/g) of the test electrode is determined from the theoretical capacity of the active material and the amount of the active material.

Then, with charging at 0.1 C for 30 minutes and pausing for 5 minutes as 1 time, the same operation is repeated 22 times in total for a coin cell for measurement.

The number of times of charging until the voltage reaches 0.05 V is defined as an SOC-OCV value.

[6] The electrode film rolled web according to any one of [1] to [5], where the conductive material may be flaky nickel particles.

[7] The electrode film rolled web according to any one of [1] to [5], where a release film may be laminated on the adhesive layer.

[8] An electrode that may include the electrode film rolled web according to any one of [1] to [7] as a material.

[9] An electrode laminate where the electrode according to [8] and any one selected from the group consisting of a current collecting foil, a separator, and a solid electrolyte membrane are laminated.

[10] An electrode laminate including: the electrode according to [8]; a first member laminated on a first surface of the electrode; and a second member laminated on a second surface of the electrode, where each of the first member and the second member is any one selected from the group consisting of a current collecting foil, a separator, and a solid electrolyte membrane.

[11] An electrochemical device that may include the electrode laminate according to [9] or [10].

[12] An apparatus that may include the electrochemical device according to [11].

According to the present invention, a novel electrode film rolled web for use as a material for an electrode can be provided. In addition, an electrode and an electrode laminate for which such an electrode film rolled web is used as a material can be provided. Furthermore, an electrochemical device including such an electrode laminate, and an apparatus including the electrochemical device can be provided.

### BRIEF DESCRIPTION OF DRAWINGS

FIG. 1 is a schematic view illustrating an electrode film rolled web 1 according to the present embodiment.

FIG. 2 is a schematic view illustrating an electrode film rolled web 2 according to the present embodiment.

FIG. 3 is a schematic view illustrating an electrode laminate 100.

FIG. 4 is a schematic view illustrating an electrode laminate 150 and a cell 500 including the electrode laminate 150.

### DETAILED DESCRIPTION

### <<Electrode Film Rolled Web and Electrode>>

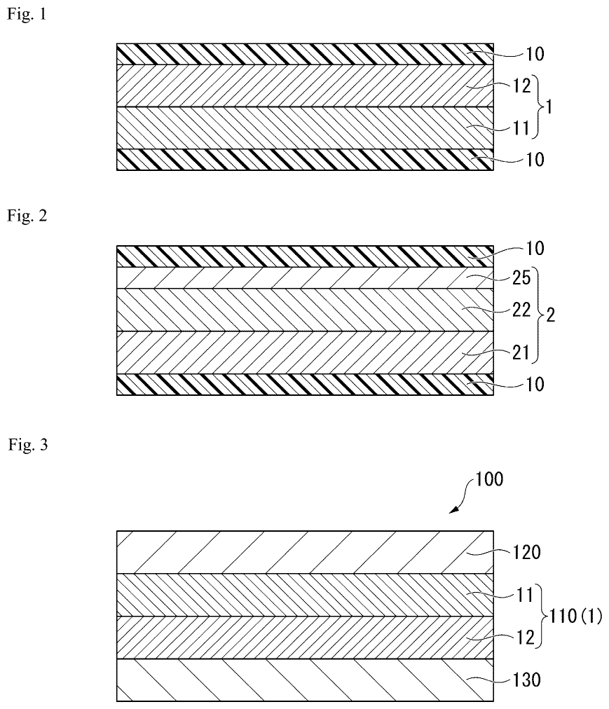

FIG. 1 is a schematic view (cross-sectional view) illustrating an electrode film rolled web 1 according to the present embodiment. An electrode according to the present embodiment includes the electrode film rolled web 1 as a material.

The term “electrode film rolled web” refers to a film-shaped molded body before being processed into an electrode. Typically, the electrode film rolled web is a long molded body formed in a strip shape, or a sheet-shaped molded body obtained by sheet-fed processing such a strip-shaped molded body.

The electrode film rolled web 1 shown in FIG. 1 is sandwiched between release films 10 from both surfaces. As the release films 10, known materials such as a release-treated PET film can be employed.

Further, the electrode film rolled web 1 in FIG. 1 has the release films 10 on both surfaces, but may have the release film 10 only on an adhesive layer 11.

The electrode film rolled web 1 is a laminate including the adhesive layer 11 and a negative active material layer 12. The electrode film rolled web 1 has no current collector.

The electrode film rolled web 1 has characteristic functions of (a) having adhesiveness, (b) being self-standing, and (c) being usable as an electrode.

### (a) Having Adhesiveness

The “adhesiveness” means a property that the electrode film rolled web 1 can be, due to the property of its surface, bonded to another member without separately using any adhesive or a pressure-sensitive adhesive. The electrode film rolled web 1 is cut into a desired shape, processed into an electrode, and then bonded to, for example, a plate material of a solid electrolyte to function as an electrode of a solid battery.

### (b) Self-Standing

The electrode film rolled web 1 can be cut into a desired shape to be processed into an electrode. The electrode film rolled web 1 may be used as an electrode as it is. The obtained electrode can maintain the cut shape without having any attachment such as a substrate. Having such a property may be referred to as “self-standing” or “self-standing type” in the present specification. In other words, the electrode film rolled web 1 has rigidity capable of existing without any support.

### (c) Usable as an Electrode

The electrode film rolled web 1 can be cut into a desired shape to be used as an electrode for an electrochemical device such as a secondary battery and a capacitor. In the present specification, whether the electrode film rolled web 1 is usable as an electrode is determined based on the value of a State of Charge (SOC)-Open Circuit Voltage (OCV).

The electrode obtained by cutting the electrode film rolled web 1 that has the functions of (a) and (c) can simplifies the operation of bonding the electrode to a member of an electrochemical device, and can be used as an electrode for an electrochemical device such as a secondary battery and a capacitor simply by bonding the electrode to a member of the electrochemical device. In addition, the electrode has the function of (b), and thus, is self-standing (a self-standing type electrode) and can be easily processed.

Hereinafter, the respective configurations of the electrode film rolled web 1 will be sequentially described.

### [Configuration of Electrode Film Rolled Web]

The electrode film rolled web 1 has a laminated structure of the adhesive layer 11 and the negative active material layer 12. As will be described in detail later, the electrode film rolled web 1 can be produced by, as an example, laminating a film corresponding to the adhesive layer 11 and a film corresponding to the negative active material layer 12.

### (Adhesive Layer)

The adhesive layer 11 includes a particulate conductive material and a binder. The adhesive layer 11 may further include a negative active material.

The adhesive layer 11 has a relatively high adhesive force, as compared with the negative active material layer 12. In addition, the adhesive layer 11 is relatively higher in strength than the negative active material layer 12 for securing the mechanical strength of the electrode film rolled web 1 as a laminate.

For achieving such physical properties, the binder constituting the adhesive layer 11 contains a polyisobutylene and a polypropylene. Specifically, the adhesive layer satisfies the following (A) and (B):
(A) The adhesive layer contains the conductive material in an amount of 13% by mass or more and 60% by mass or less, the polyisobutylene in an amount of 6% by mass or more and 20% by mass or less, and the polypropylene in an amount of 34% by mass or more and 75% by mass or less, based on 100% by mass in total of the conductive material and the binder.
(B) The ratio by mass between the polyisobutylene and the polypropylene is [polyisobutylene]: [polypropylene]=1:4 to 7.

In the adhesive layer 11, the binder composition satisfies the (A) mentioned above, thereby allowing the functions of (a) having adhesiveness, (b) being self-standing, and (c) being usable as an electrode to be appropriately achieved.

In addition, the binder composition satisfies the (B) mentioned above, thereby allowing the functions of (a) having adhesiveness and (b) being self-standing to be appropriately achieved.

In the adhesive layer 11, the conductive material is preferably 13% by mass or more and 60% by mass or less.

In the adhesive layer 11, the polyisobutylene is preferably 6% by mass or more and 20% by mass or less.

In the adhesive layer 11, the polypropylene is preferably 34% by mass or more and 75% by mass or less.

The polyisobutylene preferably has a viscosity average molecular weight of 1,000,000 or more, preferably 2,000,000 or more. On the other hand, the adhesiveness at normal temperature is decreased when the molecular weight of the polyisobutylene is excessively large, and thus, the viscosity average molecular weight is preferably 5,000,000 or less. As such a polyisobutylene, a commercially available polyisobutylene (for example, manufactured by BASF, OPPANOL, model number: N150, viscosity average molecular weight: 2,600,000) can be employed.

A polypropylene that has a glass transition temperature of 70 to 90° C. can be suitably used. As such a polypropylene, a commercially available polypropylene (for example, manufactured by Toyobo Co., Ltd., model number: V2-L, glass transition temperature: 70° C. (manufacturer's nominal value) can be employed.

The conductive material in a particulate form is dispersed in the adhesive layer. The conductive material included in the adhesive layer is at least one selected from the group consisting of a carbon material and a metal material that is not alloyed with Li.

The “metal material that is not alloyed with Li” means a metal material that does not form a solid solution with Li, and refers to a metal that has no alloyed state in a binary state diagram of the metal with Li. Examples of such a metal material include Cu, Fe, Ni, Co, Mo, W, Ta, and Pt.

As the conductive material, a material with a volume average particle size of 1 to 100 μm is used.

When the conductive material is a metal material, the conductive material may be flaky. The term “flaky” means that the particulate conductive material has a thin plate shape. The flaky conductive material preferably has an aspect ratio ([major axis of conductive material]/[thickness of conductive material]), which is the ratio of the major axis to the thickness, of 5 or more and 100 or less, more preferably 10 or more and 50 or less.

When a commercially available product is used as the flaky conductive material, the manufacturer's nominal value may be employed as the aspect ratio.

The conductive material is preferably a metal material that is not alloyed with Li, more preferably flaky nickel particles. As such a conductive material, commercially available conductive nickel flakes (for example, manufactured by HART MATERIALS Ltd., model number: HCA-1) can be employed.

As will be described in detail later, the particulate conductive material can be suitably dispersed in the adhesive layer with the use of the above-mentioned mixture of the polyisobutylene and the polypropylene as the binder of the adhesive layer.

The adhesive layer 11 may contain therein other binders as long as the effects of the invention are not impaired. Examples of the other binders include a binder constituting the negative active material layer described later.

### (Negative Active Material Layer)

The negative active material layer 12 includes a negative active material and a binder.

### (Active Material)

Powdery materials known as negative active materials for secondary batteries and capacitors can be used as the active material.

When a lithium ion secondary battery is employed as a secondary battery, examples of the negative active material of the lithium ion secondary battery include at least one selected from carbon-based materials such as graphite, lithium compounds such as metal lithium and lithium titanate, metals such as aluminum, tin, and silicon capable of forming alloys with lithium, alloys of lithium with other metals, and metal oxides such as silicon oxide. The negative active material of the lithium ion secondary battery may be a material that can be reversibly doped and dedoped with lithium ions.

As the active material for the lithium ion secondary battery, a material with a volume average particle size of 0.1 to 100 μm is used.

When a lithium ion capacitor is employed as a capacitor, examples of the negative active material of the lithium ion capacitor include carbon-based materials such as graphite, and the above-described negative electrode active materials for the lithium ion secondary battery.

As the active material for the lithium ion capacitor, a material with a volume average particle size of 0.1 to 100 μm is used.

### (Binder)

The negative active material layer 12 may be a known negative active material layer that is not self-standing only by the negative active material layer 12 itself, or may be a layer that is capable of self-standing with the following binder.

The binder is a material for use in binding particles such as an active material, and for example, a resin is used for the binder. As the binder, a known thermoplastic resin can be employed, which is used for the above-mentioned purpose as an electrode material.

Examples of the functions of the binder include (i) imparting high strength to the electrode film rolled web, (ii) making an electrode produced from the electrode film rolled web likely to adhere to another member, and (iii) adjusting other physical properties, besides the above-described “binding particles such as an active material”. (ii) is not essential for having the functions (a) and (c) necessary for the “self-standing type electrode”, but is important for achieving the function (b). Binders that especially intensively have the functions of (i), (ii), and (iii) are referred to respectively as a “high-strength binder”, an “adhesive binder”, and “other binders”, and will be described.

It is to be noted that the adhesive layer 11 has the function (ii) in the electrode film rolled web 1 according to the present embodiment. It will be described herein that the binder constituting the negative active material layer 12 includes the adhesive binder, thereby making the binder likely to adhere to another member on the surface on the negative active material layer side.

### ((i) High-Strength Binder)

As the high-strength binder, an elastomer can be used. The binder that has properties as an elastomer can impart flexibility and strength to the electrode, and can keep the electrode from being broken due to a change in the volume of the active material during use of the electrode.

The high-strength binder desirably has a breaking strength of 5 MPa or more. In addition, it is necessary for the high-strength binder to be stable against an electrolytic solution inside the electrochemical element (battery or capacitor), and electrochemically stable.

For example, in the case of employing a lithium ion battery as the electrochemical element and using an electrode obtained by cutting the electrode film rolled web 1, it is necessary for the high-strength binder not to be eluted from the electrode into the electrolytic solution filling the battery. In addition, in the case of the electrode mentioned above for a negative electrode, it is necessary for the high-strength binder not to undergo reductive decomposition at 0 to 3 V (vs. Li/Li+).

For the tensile strength of the high-strength binder, a value measured by a method for measuring the breaking strength as described later is employed.

As the binder, a copolymer containing a styrene and a conjugated diene can be used. Examples of such a copolymer include:
Styrene-butadiene copolymer (SBR);
Styrene-isoprene copolymer
Styrene-butadiene-methyl methacrylate copolymer (MBS)
Acrylonitrile-styrene-butadiene copolymer (ABS)
Acrylonitrile-styrene-butadiene-methyl methacrylate copolymer (MABS)
Carboxy-modified styrene butadiene rubber
Styrene-butadiene-styrene block copolymer (SBS)
Styrene-isoprene-styrene block copolymer (SIS)
Styrene-isoprene-butadiene-styrene block copolymer (SIBS)

The copolymers may be copolymerized with another copolymerizable vinyl-based monomer.

Examples of the vinyl-based monomer mentioned above include:
Acrylate-based monomer such as alkyl acrylate;
Methacrylate-based monomers such as alkyl methacrylates;
Acrylamide-based monomers such as alkoxyacrylamides;
Methacrylamide-based monomers such as alkoxymethacrylamides;
Carboxylic acid-based monomers such as acrylic acids;
Nitrile-based monomers such as acrylonitrile;
Vinyl ester-based monomers such as vinyl acetates;
Vinyl halide-based monomers such as vinyl chlorides; and
Polyfunctional monomers such as allyl acrylates.

One of these vinyl-based monomers may be copolymerized with the copolymer mentioned above, or two or more thereof may be copolymerized.

((ii) Adhesive Binder)

As the adhesive binder, a resin material that has a reactive functional group or an anchor effect can be used. Examples of the reactive functional group include a hydroxyl group (—OH) and a carboxy group (—COOH). When the electrode film rolled web contains such a binder, in bonding an electrode obtained from the electrode film rolled web to another member, the reactive functional group can be expected to react at the bonded surface to increase the adhesive strength.

In addition, the electrode film rolled web contains the adhesive binder, thereby making a self-standing type electrode produced from the electrode film rolled web likely to exhibit the function (ii) mentioned above.

Desirably, the adhesive binder is electrochemically stable and has adhesiveness even when the binder is exposed to other members, especially an electrolytic solution.

For example, in the case of employing a lithium ion battery as an electrochemical element and using an electrode obtained by cutting the electrode film rolled web 1, it is necessary for the adhesive binder not to be eluted from the electrode into an electrolytic solution filling the battery, and it is necessary for the reactive functional group to be unlikely to be deactivated even when the binder is exposed to the electrolytic solution.

In the case of the electrode mentioned above for a negative electrode, it is necessary for the adhesive binder not to undergo reductive decomposition at 0 to 3 V (vs. Li/Li⁺).

Examples of such a binder include at least one selected from carboxymethyl cellulose (CMC)-based binders, polyacrylic acid (PAA)-based binders, vinyl alcohol-based binders, and epoxy-based binders.

In addition, polyisobutylene (PIB) can also be used as the adhesive binder.

((iii) Other Binders)

Examples of binders that can be used in combination may include an acrylate-based binder, a polyvinylidene fluoride (PVdF)-based binder, and a polyimide-based binder. These binders are capable of compensating for the insufficient function as the electrode. For example, the (i) high-strength binder is considered electrochemically inactive, and when the active material is completely covered with the (i) high-strength binder, the electrochemical reaction of the active material is considered to fail to be developed, and the resistance of the electrode is considered to be increased. In contrast, the use of the (iii) other binders as described above in combination is considered to keep the resistance from being increased by covering the active material with the inactive binder.

The blending of the binders (i) to (iii) is adjusted depending on the intended physical properties, based on the following guidelines.

The (i) high-strength binder mainly plays a role of binding the active material in the electrode (electrode film rolled web). Thus, the amount of the high-strength binder (i) is adjusted in a positive correlation, depending on the amount of the active material used.

In addition, the (i) high-strength binder can impart flexibility and strength to the electrode as the amount of the (i) high-strength binder used for the active material is increased. Furthermore, the (i) high-strength binder may exhibit adhesiveness.

The (ii) adhesive binder imparts adhesiveness to the electrode film rolled web. The adhesiveness of the electrode is determined by the amount of the binder that exhibits adhesiveness, present per unit area (unit volume), and thus, the increased amount of the adhesive binder (ii) used improves the adhesiveness of the electrode.

The (iii) other binders are added, as necessary, for compensating for the insufficient function as the electrode.

Furthermore, the negative active material layer 12 may contain, besides the above-described active material and binder, an additive such as a conductive material, as necessary, for adjusting the physical properties. Examples of the conductive material include at least one selected from materials, for example, carbon black such as acetylene black, carbon fibers, activated carbon, metal powders, and conductive polymers. It is not necessary for the conductive material to have any activity like the active material, and may be any material that improves the conductivity inside the electrode.

In addition, the mixture constituting the electrode film rolled web may contain carbon nanotubes (CNT). The electrode film rolled web with CNTs added thereto can be expected to have an improvement in breaking strength and an improvement in conductivity.

### (Electrode Film Rolled Web)

The thickness of the electrode film rolled web 1 is preferably 1 μm or more and 1,000 μm or less.

The adhesive layer 11 is preferably 7% by volume or more and 17% by volume or less of the electrode film rolled web 1. In addition, the negative active material layer 12 is preferably 83% by volume or more and 93% by volume or less of the electrode film rolled web 1.

The adhesive layer 11 that has such a configuration described above is relatively more likely to be deformed and elongated than the negative active material layer 12. Thus, in the case of a stress applied to the electrode film rolled web 1, the whole shape of the electrode film rolled web 1 can be maintained (self-standing) without any breakage of the adhesive layer 11, even when the stress applied is enough to break the negative active material layer 12.

The electrode film rolled web 1 preferably satisfies the following requirements (1) and (3) for exhibiting the functions of (a) having adhesiveness and (c) being usable as an electrode. Furthermore, the electrode film rolled web preferably satisfies the following requirement (2) for exhibiting the function of (b) being self-standing.

### (Requirement (1))

For a test piece of the electrode film rolled web 1 bonded under the following bonding condition 1, the normal-temperature adhesive strength in a 90° peeling test is 0.03 N/cm or more, preferably 0.04 N/cm or more.

### (Bonding Condition 1)

Roll bonding under an environment at a pressure of 8.6 kg/cm, a speed of 1 m/min, and 25° C.

The electrode film rolled web 1 that satisfies the requirement (1) has the above-described feature of “(a) having adhesiveness”.

### (Method for Measuring Adhesive Strength)

The adhesive layer side of a test piece of 15 mm in width and 50 mm in length, cut out from the electrode film rolled web, is bonded onto the center of a copper foil of 15 mm in width and 60 mm in length. The bonding is performed under the following condition.

Specifically, the electrode film rolled web is cut into a width of 50 mm and a length of 150 mm, and bonded to a copper foil of 60 mm in width and 200 mm in length under the bonding condition. While maintaining the dimension of the obtained laminate in the lateral direction, the laminate is cut into a plurality of pieces in the longitudinal direction to obtain a laminate where the electrode film of 15 mm in width and 50 mm in length (the width of the original electrode film) is laminated on the copper foil of 15 mm in width and 60 mm in length (the width of the original copper foil).

The obtained laminate is attached from the copper foil side to a ring core of 11 cm in diameter, and the electrode film portion is pulled at a speed of 20 mm/min to perform a 90° peeling test. The adhesive strength can be determined as a value (N/cm) obtained by dividing the magnitude of the peeling force (N) in peeling the electrode film from the metal foil by the width (cm) of the electrode film.

The arithmetic mean value of three values obtained by performing the peeling test three times is employed for the adhesive strength.

In the peeling test, the electrode film may be failed to be ideally peeled from the metal foil. In each of such cases, the determination is made as follows.

First, when an attempt is made to peel the electrode film from the metal foil in the peeling test, the electrode film may be damaged or broken. In this case, the value measured when the electrode film is damaged or broken is employed as a value in place of the peeling force (N) to determine the adhesive strength. When the electrode film is brittle and thus damaged, the value in place of the peeling force is also a small value, and is determined as a small adhesive strength. When it is difficult to peel the electrode film due to the strong adhesive force of the electrode film, the value of in place of the peeling force is also a large value, and is determined as a large adhesive strength.

In addition, when an attempt is made to peel the electrode film as a laminate from the metal foil, interfacial peeling may occur between the adhesive layer and the negative active material layer. In this case, the value measured when the electrode film undergoes the interfacial peeling is employed as a value in place of the peeling force (N) to determine the adhesive strength. Even in this case, as long as the interfacial peeling strength is 0.03 N/cm or more at the time of measuring the normal-temperature adhesive strength, the normal-temperature adhesive strength of the electrode film can be determined to be at least 0.03 N/cm or more.

As described above, the adhesive strength can be determined in the peeling test, and whether the requirement (1) is satisfied or not can be determined.

When the electrode film rolled web has such an adhesive strength, the electrode obtained from the electrode film rolled web is easily bonded to another member, and kept from being peeled due to its own weight. Thus, the subsequent assembling process is facilitated. In addition, the bonded electrode is unlikely to be peeled off, and the reliability of the electrochemical device obtained is improved.

Furthermore, for a test piece of the electrode film rolled web 1 bonded under the following bonding condition 2, the heated adhesive strength in a 90° peeling test that is performed by the measurement method described above is preferably 0.10 N/cm or more.

### (Bonding Condition 2)

Roll bonding under an environment at a pressure of 8.6 kg/cm, a speed of 1 m/min, and 50° C.

When the electrode film fails to be ideally peeled from the metal foil in the peeling test at the time of measuring the heated adhesive strength, the determination can be made based on the same idea as in the measurement of the normal-temperature adhesive strength.

The ratio of the binder to the whole mixture may be adjusted depending on physical properties that are necessary for the electrode film rolled web to be formed. When the adhesive force to other members such as a separator is prioritized for an electrode that is produced from the electrode film rolled web, the content ratio of the binder is preferably increased within the range mentioned above. When the electrical characteristics of the electrode are prioritized, the content ratio of the binder is preferably reduced within the range mentioned above.

### (Requirement (2))

As described above, the electrode film rolled web 1 preferably has the feature of “(2) being self-standing”. The electrode film rolled web 1 with such rigidity has a breaking strength of 0.5 MPa or more as determined by the following measurement method.

### (Method for Measuring Breaking Strength)

The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

The magnitude of the tensile force (N) on the breakage of the test piece is defined as the maximum stress, and the stress of 75% of the maximum stress is determined. The value (N/mm²=MPa) obtained by dividing the stress (N) of 75% by the cross-sectional area (mm²) of the test piece in an imaginary plane orthogonal to the tensile direction is determined as the breaking strength.

The arithmetic mean value of three values obtained by performing the measurement three times is employed for the breaking strength.

The electrode film rolled web has such breaking strength, thereby allowing an electrode cut from the electrode film rolled web to be self-standing. Allowing the electrode to be self-standing makes it easy to handle the electrode in the subsequent assembly process.

The breaking strength is preferably 0.6 MPa or more, more preferably 0.7 MPa or more. In addition, the breaking strength can be considered preferably higher because the web is less likely to be broken, but the breaking strength may be 10 MPa or less, and may be 5 MPa or less.

### (Requirement (3))

As described above, the electrode film rolled web 1 has the feature of “(c) being usable as an electrode”. As described above, whether the electrode film rolled web 1 is usable as an electrode is determined based on the SOC-OCV value.

### (Fabrication of Coin Cell for Measurement)

On a lower lid for the coin-type battery R2032, a test electrode prepared from the electrode film rolled web is disposed. On the test electrode, a separator (Celgard 2300 manufactured by Celgard, LLC) is disposed, and then, an electrolytic solution (1 mol/L solution of LiPF₆) is injected. As a solvent for the electrolytic solution, a mixed solvent obtained by mixing an ethylene carbonate, a diethyl carbonate, and an ethyl methyl carbonate at 1:1:1 (volume ratio) is used.

On the separator, a counter electrode (metal lithium) is disposed, and covered with a lid, and then, the whole is left to stand for 12 hours to immerse the whole in the electrolytic solution, thereby fabricating a lithium secondary battery (coin cell for measurement).

### (Method for Measuring SOC-OCV Value)

The amount of the active material included in the test electrode prepared from the electrode film rolled web is calculated, and the theoretical capacity (mAh/g) of the test electrode is determined from the theoretical capacity of the active material and the amount of the active material.

Then, with charging at 0.1 C for 30 minutes and pausing for 5 minutes as 1 time, the same operation is repeated 22 times in total for a coin cell for measurement.

The number of times of charging until the voltage reaches 0.05 V is defined as an SOC-OCV value.

In the present specification, when the SOC-OCV value measured by the method above is 18 times or more, the electrode film rolled web is determined to be adequately usable as an electrode.

When the electrode film rolled web shows such an SOC-OCV value, an electrode obtained from the electrode film rolled web adequately functions as a battery.

Furthermore, the electrode film rolled web 1 preferably has a volume resistivity of 80 mΩ or less. The electrical resistance of the electrode film rolled web 1 can be measured by the following method.

### (Method for Measuring Volume Resistivity)

First, the main surfaces of a pair of Cu blocks are superposed on each other, a load of 2 kg is then applied to the blocks, and zero-point calibration is performed. The Cu blocks used each have a main surface of 30×30 mm and a thickness of 20 mm.

Then, a test piece of the electrode film rolled web is sandwiched between the main surfaces of the pair of Cu blocks, and a load of 2 kg is applied. The test piece is 30×30 mm in plane view, which is the same as the main surface of the Cu block.

Then, the resistance after 2 minutes is measured, and defined as the electrical resistance of the test piece. The electrical resistance is measured with the use of, for example, a battery high tester (model number: BT3562, manufactured by HIOKI E.E. CORPORATION).

In comparing the volume resistivity of different electrode film rolled webs with each other, the test pieces to be compared are controlled to have the same thickness. The thickness of the electrode film rolled web can be controlled by the method described in the production method described later.

### [Method for Producing Electrode Film Rolled Web]

The electrode film rolled web can be produced by applying, onto a support, a slurry (coating material) obtained by dissolving or dispersing the above-described mixture in a solvent, removing the solvent to produce each of a film corresponding to the adhesive layer 11 and a film corresponding to the negative active material layer 12, and laminating the obtained films on each other.

For the solvent, a solvent that dissolves at least the binder is used. Examples of the solvent include a hydrocarbon-based solvent, an alcohol-based solvent, an ether-based solvent, a ketone-based solvent, an ester-based solvent, an amide-based solvent, a halogen-based solvent, a sulfur-based solvent, and an inorganic solvent.

Examples of the hydrocarbon-based solvent include heptane, cyclohexane, toluene, and xylene.

Examples of the alcohol-based solvent include methanol and ethanol.

Examples of the ether-based solvent include tetrahydrofuran and dioxane.

Examples of the ketone-based solvent include acetone and methyl ethyl ketone.

Examples of the ester-based solvent include ethyl acetate and ethyl lactate.

Examples of the amide-based solvent include dimethylformamide and N-methyl-2-pyrrolidone.

Examples of the halogen-based solvent include chloroform and dichloromethane.

Examples of the sulfur-based solvent include dimethyl sulfoxide and sulfolane.

Examples of the inorganic solvent include water.

Only one of the solvents mentioned above may be used, or a mixed solvent obtained by mixing two or more of the solvents may be used.

The method for preparing the coating material is not particularly limited, but the active material, the binder, an optionally added additive, and the like may be mixed with the solvent one by one, or two or more thereof may be mixed at the same time with the solvent, and dissolved or dispersed in the solvent.

The order of adding the solid contents (active material, binder, optionally added additive) to the solvent is not limited. The insoluble component may be added to a solution obtained by dissolving the soluble component in the solvent to disperse the insoluble component in the solution. In addition, the soluble component may be added to a dispersion obtained by dispersing the insoluble component in the solvent to dissolve the soluble component in the dispersion.

After the slurry or solution is prepared, a solvent may be further added to adjust the viscosity of the coating material.

The condition of the coating material may be adjusted by a treatment such as defoaming or filtration. Additives such as an antifoaming agent, a viscosity modifier, a thickener, a diluent, a surfactant, and a stabilizer may be added to the coating material.

The method for applying the coating material is not particularly limited, and examples thereof include blade coating, dip coating, spray coating, bar coating, and die coating.

The object (support) to which the coating material is applied is preferably a release-treated resin film. The support may be a long strip-shaped support, or may be a small sheet obtained by sheet-fed processing a long support.

By removing the solvent from the coating film formed by applying the coating material, a film corresponding to the adhesive layer 11 and a film corresponding to the negative active material layer 12 can be formed. The solvent can be removed by heating, depressurization, blowing, and a combination thereof.

The dried coating film may be subjected to pressing. For example, compressing the dried coating film with a pressing machine or the like can improve the contact states of particles such as the active material and conductive material included in the electrode. In addition, the pressing can control the density of the negative active material in the negative active material layer 12 and the thickness of the negative active material layer 12.

For example, the obtained coating material is applied to a release-treated PET film so as to be 3.3 mAh/cm². Specifically, the mass per unit area (applied mass; unit:g/cm²) of the active material was calculated from the target capacity of the electrode and the specific capacity (unit:mAh/g) of the active material to be used, and the coating material was then applied. The coating film is dried by heating the film at 90° C. for 5 minutes, and then compressed with a roll press machine to be 1.4 g/cm³ in density, thereby allowing a film corresponding to the negative active material layer to be obtained.

The obtained films (the film corresponding to adhesive layer 11 and the film corresponding to negative active material layer 12) can be laminated to produce an electrode film rolled web. At the time of laminating the films, pressing is preferably performed.

In the case of using, as the support, a long strip-shaped support, the electrode film rolled web may be wound into a roll, stored, and transported, or may be further subjected to sheet-fed processing to provide a plurality of sheet-shaped electrode film rolled webs.

In this manner, the electrode film rolled web 1 is obtained.

FIG. 2 is a schematic view illustrating an electrode film rolled web 2 according to the present embodiment.

The electrode film rolled web 2 shown in FIG. 2 has an adhesive layer 21, a negative active material layer 22, and a functional layer 25. The electrode film rolled web 2 is also sandwiched between release films 10 from both surfaces. The adhesive layer 21 and the negative active material layer 22 may have the same configurations respectively as the adhesive layer 11 and negative active material layer 12 described above.

Further, the electrode film rolled web 2 in FIG. 2 has the release films 10 on both surfaces, but may have the release film 10 only on an adhesive layer 21.

The electrode film rolled web 2 has no current collector.

The same mixtures as the mixture constituting the electrode film rolled web 1 described above can be employed for the mixtures constituting the adhesive layer 21 and the negative active material layer 22.

The functional layer 25 is provided in contact with the opposite surface of the negative active material layer 22 from the adhesive layer 21. The functional layer 25 is not particularly limited as long as the functional layer 25 is a layer attached for the purpose of improving the function of the electrode. Examples of the functional layer 25 include a heat dissipation layer, a flattening layer, a stress relaxation layer, and an adhesion layer.

The electrode film rolled web 2 can be produced by preparing the adhesive layer 21 and the negative active material layer 22 corresponding to the electrode film rolled web 1 in the same manner as the electrode film rolled web 1 described above, and then preparing the functional layer 25 on the surface of the negative active material layer 22. The functional layer 25 can be appropriately produced by a known method with the use of a known material.

The electrode film rolled web that has such a configuration as described above can provide a novel electrode film rolled web for use as a material for an electrode.

In addition, the electrode that has such a configuration as described above has a sufficient adhesive force, and is easy to handle at the time of assembling a battery.

### [Electrode Laminate]

FIG. 3 is a schematic view (cross-sectional view) illustrating an electrode laminate 100. The electrode laminate 100 is a laminate where an electrode 110 and any one layer 120 selected from the group consisting of a current collecting foil, a separator, and a solid electrolyte membrane are laminated. The electrode 110 has the same configuration as the electrode produced from the electrode film rolled web 1 described above, and has a laminate of the adhesive layer 11 and the negative active material layer 12. The electrode 110 adheres to the layer 120 at the adhesive layer 11.

When the electrode laminate 100 is incorporated into a battery or a capacitor, the electrode 110 functions as a negative electrode. Hereinafter, the electrode 110 is referred to as a negative electrode 110.

When the layer 120 is a separator, the electrode laminate 100 including the negative electrode 110 and the separator is mainly used for an electrochemical device in which an electrolytic solution is used.

The separator is a material that insulates a positive electrode from a negative electrode and has ion permeability that is necessary for the function of the electrode. The separator is not particularly limited, and known resin films, porous membranes, and the like can be used.

Examples of the resin films include polypropylene, polyethylene, polyolefin, aramid, polyvinylidene fluoride, polyacrylonitrile, polyimide, polyamide, and polyethersulfone. For imparting ion permeability, the resin film may be made porous.

Examples of the porous membranes include a woven fabric, a nonwoven fabric, cellulose, and ceramic.

When the layer 120 is a solid electrolyte membrane, the electrode laminate 100 including the negative electrode 110 and the solid electrolyte membrane is used for an all-solid-state secondary battery, which is a type of electrochemical device.

The solid electrolyte membrane is a member obtained by processing a generally known solid electrolyte into a plate or a membrane. As a material for the solid electrolyte membrane, any of generally known inorganic solid electrolytes and polymeric solid electrolytes can be used.

As the inorganic solid electrolytes, any of sulfide-based inorganic solid electrolytes, oxide-based inorganic solid electrolytes, and other lithium-based inorganic solid electrolytes can be used.

Examples of the sulfide-based inorganic solid electrolytes include Li₂S—P₂S₅, Li₂S—SiS₂, Li₂S—GeS₂, Li₂S—Al₂S₃, Li₂S—SiS₂—Li₃PO₄, Li₂S—P₂S₂—GeS₂, Li₂S—Li₂O—P₂S₂—SiS₂, Li₂S—GeS₂—P₂S₅—SiS₂, and Li₂S—SnS₂—P₂S₁—SiS₂.

Examples of the oxide-based inorganic solid electrolytes include NASICON-type materials such as LiTi₂ (PO₄)₃, LiZr₂ (PO₄)₃, and LiGez (PO₄)₃, and perovskite-type materials such as (La_{0.5+x}Li_{0.5-3x})TiO₃.

Examples of the other lithium-based inorganic solid electrolyte materials include LiPON, LiNbO₃, LiTaO₃, Li₃PO₄, LiPO₄₋ₓNₓ (x is 0<x≤1), LIN, LiI, and LISICON.

Examples of the polymeric solid electrolytes include polymer materials that exhibits ion conductivity, such as a polyethylene oxide, a polypropylene oxide, and copolymers thereof.

When the layer 120 is a current collecting foil, the electrode laminate 100 including the negative electrode 110 and the current collecting foil is widely used for an electrochemical device. The electrode laminate 100 including the negative electrode 110 and the current collecting foil (layer 120) has a function of an electrode (negative electrode) as a whole. In such a case, the negative electrode 110 may adhere to the layer 120 at the negative active material layer 12, and may be bonded to a separator, a solid electrolyte membrane, or the like at the adhesive layer 11 of the negative electrode 110.

The negative electrode 110 may have another member 130 on the surface of the negative active material layer 12. Examples of the other member 130 include a protective film that protects the electrode surface. The protective film is not particularly limited as long as the film is a material capable of protecting the electrode from falling off of particles such as the active material at the surface of the electrode, any excessive reaction between the electrolyte and the electrode, and the like.

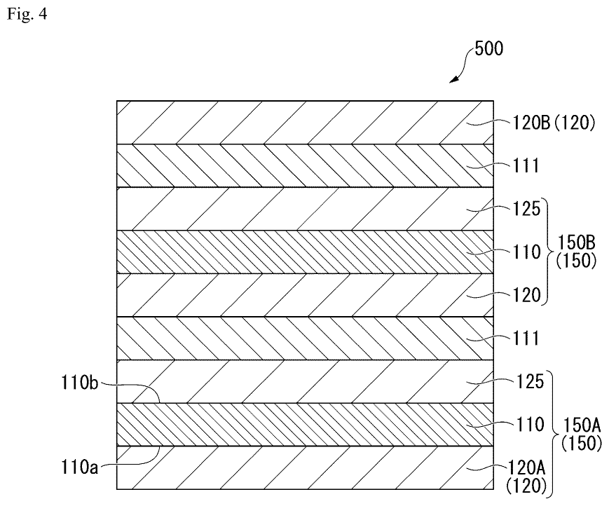

FIG. 4 is a schematic view (cross-sectional view) illustrating an electrode laminate 150 and a cell 500 including the electrode laminate 150. The electrode laminate 150 includes the negative electrode 110 described above, a first member 120 laminated on a first surface 110a of the negative electrode 110, and a second member 125 laminated on the second surface 110b of the negative electrode 110.

The first member 120 and the second member 125 are each any one selected from the group consisting of a current collecting foil, a separator, and a solid electrolyte membrane, and correspond to the layer 120 in FIG. 3. The first member 120 and the second member herein respectively serve as a current collecting foil and a solid electrolyte membrane.

The cell 500 has two electrode laminates 150, and a positive electrode 111 is sandwiched between the second member 125 of one electrode laminate 150A and the first member 120 of the other electrode laminate 150B. In addition, the positive electrode 111 and the first member 120 (first member 120B) are laminated in this order on the second member 125 of the electrode laminate 150B.

The negative electrode 110 and the positive electrode 111 each may have direct contact with the first member 120 and the second member 125, or may have another member sandwiched therebetween. As the other members, the same members as those described above can be employed.

The cell 500 functions as a bipolar battery including the first member 120A as a negative electrode side terminal and the first member 120B as a positive electrode side terminal.

In the cell 500 that has such a configuration, an electrode (negative electrode) formed from the electrode film rolled web described above is used for the negative electrode 110. The negative electrode 110 has the functions of (a) having adhesiveness and (b) being usable as an electrode, and thus, the negative electrode 110 is formed by cutting out from the electrode film rolled web, and stacked on the first member 120 or the second member 125, thereby allowing the interface to be easily bonded and allowing the negative electrode 110 and the member to be easily laminated.

### [Electrochemical Device]

The electrochemical device includes the electrode laminate mentioned above. Examples of the electrochemical device include a secondary battery and a capacitor.

Examples of the secondary battery include a battery cell, a module fabricated by connecting a plurality of cells, and a pack fabricated by connecting a plurality of modules. The product of the electrochemical device may include a sensor, a control circuit, and the like for keeping abnormalities such as overcharge and overdischarge from being caused. For electrically connecting the battery to the outside, a lead (terminal) may be attached to the electrode.

The electrode laminate including a separator is used for a secondary battery including an electrolytic solution. Examples of the electrolyte of a lithium ion secondary battery include a solution that has a lithium salt dissolved in a nonaqueous solvent. Examples of the lithium salt include LiPF₆, LiBF₄, LiAlCl₄, LiClO₄, CF₃SO₃Li, C₄F₉SO₃Li, CF₃COOLi, (CF₃CO)₂NLi, (CF₃SO₂)₂NLi, and (C₂F₂SO₂)₂NLi. Examples of the nonaqueous solvent include carbonates (carbonate esters) such as ethylene carbonate (EC), propylene carbonate (PC), dimethyl carbonate (DMC), diethyl carbonate (DEC), and ethyl methyl carbonate (EMC).

The electrochemical device can be fabricated by combining the electrode laminate mentioned above with other necessary members, for example, a separator, another electrode (counter electrode), and the like. The counter electrode may be different from the electrode according to the present embodiment.

The container for housing the electrode laminate can be formed from a laminate film, metal, or the like. The electrode laminate may be disposed in a flat form in the container, or may be housed in a from such as a curved, bent, or wound form.

### [Apparatus]

A module can be fabricated by connecting a plurality of cells. A pack can be fabricated by connecting a plurality of modules. The apparatus fabricated with the use of a battery such as a cell, a module, or a pack is not particularly limited, and examples thereof include electronic apparatuses such as a smartphone, a mobile phone, a computer, and a display, and transportation apparatuses such as an electric vehicle and a hybrid vehicle.

The preferred embodiments according to the present invention have been described above with reference to the accompanying drawings, but the present invention is not limited to such examples. The various shapes, combinations, and the like of the respective constituent members shown in the examples described above are merely examples, and various modifications can be made based on design requirements and the like without departing from the gist of the present invention.

### EXAMPLES

The present invention will be described below with reference to examples, but the present invention is not limited to these examples.

### Examples 1 to 7 and Comparative Examples 1 to 10

The respective materials used in examples and comparative examples are as follows.

### (Binder)

N150: polyisobutylene, manufactured by BASF, model number N150
6T: polyisobutylene, manufactured by ENEOS Corporation, model number 6T
V2-L: polypropylene, manufactured by Toyobo Co., Ltd., model number V2-L
SBR: styrene-butadiene rubber, manufactured by Sigma-Aldrich, model number 182877
CMC: carboxymethyl cellulose, manufactured by Daicel Corporation, model number 2200

### (Active Material (Negative Active Material))

model number MAGE3 manufactured by Showa Denko Materials Co., Ltd.

### (Conductive Material)

C45: acetylene black, manufactured by Imerys S.A., model number C45
Ni: conductive nickel flakes, manufactured by HART MATERIALS Ltd., model number HCA-1
   (Production of Film corresponding to Adhesive Layer)

After dissolving the respective binders in a solvent to form a solution with the following concentration, each of the binders was mixed at the ratio by weight shown in Table 1 in terms of binder to obtain binder solutions S1 to S10.
N150: 6% by mass toluene solution
6T: 24% by mass cymene solution
V2-L: 6% by mass toluene solution

TABLE 1

| | N150 | V2-L | 6T |
|---|---|---|---|
| S1 | 1 | — | 2 |
| S2 | 1 | — | 1 |
| S3 | 2 | — | 1 |
| S4 | 1 | 1 | — |
| S5 | 1 | 2 | — |
| S6 | 1 | 3 | — |
| S7 | 1 | 4 | — |
| S8 | 1 | 5 | — |
| S9 | 1 | 6 | — |
| S10 | 1 | 7 | — |

The obtained binder solutions were each mixed with a conductive material at the ratio shown in Table 2 in terms of binder to form a slurry. Toluene was further added to adjust the viscosity.

The slurry was defoamed and passed through a sieve with a mesh size of 100 μm to obtain respective coating materials for adhesive layer formation.

The obtained coating materials were each applied to a release-treated PET film. The coating films were dried by heating the films at 90° C. for 5 minutes to obtain films A1 to A17 corresponding to the adhesive layer. Table 2 also shows the composition (% by mass) of the components in the films A1 to A17.

TABLE 2

| | Binder | Conductive | Composition (% by mass) | | | |
|---|---|---|---|---|---|---|
| | Solution | Material (%) | N150 | 6T | V2-L | Ni |
| A1 | S1 | 15 | 28.99 | 57.97 | — | 13.04 |
| A2 | S2 | | 43.48 | 43.48 | | 13.04 |
| A3 | S3 | | 57.97 | 28.99 | | 13.04 |
| A4 | S4 | | 43.48 | — | 43.48 | 13.04 |
| A5 | S5 | | 28.99 | | 57.97 | 13.04 |
| A6 | S6 | | 21.74 | | 65.22 | 13.04 |
| A7 | S7 | | 17.39 | | 69.57 | 13.04 |
| A8 | S8 | | 14.49 | | 72.46 | 13.04 |
| A9 | S9 | | 12.42 | | 74.53 | 13.04 |
| A10 | S10 | | 10.87 | | 76.09 | 13.04 |
| A11 | S8 | 25 | 13.33 | | 66.67 | 20.00 |
| A12 | | 50 | 11.11 | | 55.56 | 33.33 |
| A13 | | 100 | 8.33 | | 41.67 | 50.00 |
| A14 | | 125 | 7.41 | | 37.04 | 55.56 |
| A15 | | 150 | 6.67 | | 33.33 | 60.00 |
| A16 | | 175 | 6.06 | | 30.30 | 63.64 |
| A17 | | 200 | 5.56 | | 27.78 | 66.67 |

### (Production of Film Corresponding to Negative Active Material Layer)

After dissolving each of the binders in a solvent to form a solution with the following concentration, the binder was mixed at a ratio by mass of SBR:CMC=2:1 in terms of binder to obtain a binder solution.
SBR: 45% by mass aqueous solution
CMC: 1.5% by mass aqueous solution

The conductive material (C45) of 0.33% by mass in terms of binder was mixed with the obtained binder solution to form a slurry. Toluene was further added to adjust the viscosity.

The slurry was defoamed and passed through a sieve with a mesh size of 100 μm to obtain a coating material for negative active material layer formation.

The obtained coating material was applied to a release-treated PET film so as to be 3.3 mAh/cm². Specifically, the mass per unit area (applied mass; unit:g/cm²) of the active material was calculated from the target capacity of the electrode and the specific capacity (unit:mAh/g) of the active material to be used, and the coating material was then applied. The coating film was dried by heating at 90° C. for 5 minutes. After the drying, the dried coating film was compressed with a roll press machine to be 1.4 g/cm³ in density, thereby providing a film corresponding to the negative active material layer.

### (Production of Electrode Film Rolled Web)

The film corresponding to the negative active material layer and the film corresponding to the adhesive layer, described above, were combined and laminated to fabricate electrode film rolled webs according to examples and comparative examples. Physical property values were measured for each of the electrode film rolled webs.

### [Measurement of Adhesive Strength]

The adhesive strength was measured by the method described in (Method for Measuring Adhesive Strength) described above.

The normal-temperature adhesive strength was measured for a test piece bonded in accordance with the (Bonding Condition 1) described above. In addition, the heated adhesive strength was measured for a test piece bonded in accordance with the (Bonding Condition 2) described above.

### [Measurement of Breaking Strength]

The breaking strength was measured by the method described in (Method for Measuring Breaking Strength) described above.

### [Measurement of Volume Resistivity]

The volume resistivity was measured by the method described in (Method for Measuring Volume Resistivity) described above.

### [Measurement of SOC-OCV Value]

The SOC-OCV value was measured by the method described in (Method for Measuring SOC-OCV Value).

The evaluation results are shown in Table 3.

TABLE 3

| | | | | | | SOC- |
|---|---|---|---|---|---|---|
| | | Adhesive Strength | | | | OCV |
| | | (N/cm) | | Volume | Breaking | Value |
| | Adhesive | Normal- | | Resistivity | Strength | Times |
| | Layer | temperature | Heated | (mΩ) | (MPa) | (5%/time) |
| Comparative | A1 | 1.04 | — | 50 | 0.15 | — |
| Example 1 | | | | | | |
| Comparative | A2 | 0.71 | — | 60 | 0.19 | — |
| Example 2 | | | | | | |
| Comparative | A3 | 0.36 | — | 70 | 0.23 | 16 |
| Example 3 | | | | | | |
| Comparative | A4 | 0.13 | — | 80 | 0.33 | — |
| Example 4 | | | | | | |
| Comparative | A5 | 0.09 | — | 100 | 0.48 | — |
| Example 5 | | | | | | |
| Comparative | A6 | 0.07 | 0.49 | 80 | 0.62 | 16 |
| Example 6 | | | | | | |
| Example 1 | A7 | 0.05 | 0.73 | 80 | 0.76 | 18 |
| Example 2 | A8 | 0.04 | 0.95 | 80 | 0.87 | 20 |
| Example 3 | A9 | 0.03 | 1.12 | 80 | 0.93 | 19 |
| Comparative | A10 | 0.02 | 1.27 | 70 | 0.98 | — |
| Example 7 | | | | | | |
| Example 4 | A11 | 0.04 | 0.95 | 70 | 0.86 | 20 |
| Example 5 | A12 | 0.04 | 0.91 | 60 | 0.81 | 20 |
| Example 6 | A13 | 0.04 | 0.83 | 50 | 0.78 | 21 |
| Example 7 | A14 | 0.03 | 0.74 | 50 | 0.74 | 20 |
| Comparative | A15 | 0.02 | 0.66 | 60 | 0.72 | 20 |
| Example 8 | | | | | | |
| Comparative | A16 | No | — | — | 0.71 | — |
| Example 9 | | adhesiveness | | | | |
| Comparative | A17 | No | — | — | 0.66 | — |
| Example 10 | | adhesiveness | | | | |

The electrodes according to Examples 1 to 7 all exhibited adhesive strengths significantly in excess of 0.03 N/cm at normal temperature, and thus, it has been suggested that the electrodes are easily bonded to other members. In addition, the SOC-OCV value was 18 times or more, and thus, being usable as an electrode has been successfully confirmed.

Furthermore, it has been successfully confirmed that the electrodes according to Example 1 to 7 are self-standing.

In contrast, the electrode according to Comparative Examples 1 to 5 were low in breaking strength, and thus, have been found to have difficulty with self-standing.

In addition, the electrodes according to Comparative Examples 3 and 6 have SOC-OCV values below the standard, and thus, have been found to be low in performance as an electrode.

Furthermore, the electrode according to Comparative Examples 7 to 10 were insufficient in adhesiveness.

That is, the electrodes according to Comparative Examples 1 to 10 fail to be considered as self-standing type electrodes with adhesiveness, and it has been successfully confirmed that the electrodes fail to solve the problem of the present invention.

From the foregoing results, the present invention has been found to be useful.

### DESCRIPTION OF THE REFERENCE NUMERALS

1, 2 Electrode film rolled web
10 Release film
11, 21 Adhesive layer
12, 22 Negative active material layer
100, 150, 150A, 150B Electrode laminate
110 Electrode
110a First surface
110b Second surface
120, 120A, 120B First member
125 Second member

What is claimed is:

1. An electrode film rolled web comprising:
an adhesive layer; and
a negative active material layer laminated on the adhesive layer and including a negative active material,
wherein the adhesive layer includes a particulate conductive material and a binder,
the binder contains a polyisobutylene and a polypropylene,
the conductive material is at least one selected from the group consisting of a carbon material and a metal material that is not alloyed with Li, and
the adhesive layer satisfies the following (A) and (B):
(A) the adhesive layer contains the conductive material in an amount of 13% by mass or more and 60% by mass or less, the polyisobutylene in an amount of 6% by mass or more and 20% by mass or less, and the polypropylene in an amount of 34% by mass or more and 75% by mass or less, based on 100% by mass in total of the conductive material and the binder; and
(B) a ratio by mass between the polyisobutylene and the polypropylene is [polyisobutylene]:[polypropylene]=1:4 to 7.

2. The electrode film rolled web according to claim 1, wherein a breaking strength determined by the following measurement method is 0.5 MPa or more:
(Measurement Method)
The strength of 75% of the maximum stress is defined as breaking strength, when a test piece obtained by cutting the electrode film rolled web into a size of 15 mm in width and 50 mm in length is measured under the conditions of inter-chuck distance: 30 mm and tensile speed: 100 mm/min.

3. The electrode film rolled web according to claim 1, wherein for a test piece thereof bonded under the following bonding condition 1, a normal-temperature adhesive strength in a 90° peeling test performed by the following measurement method is 0.03 N/cm or more:
(Measurement Method)
The strength is measured when a test piece of 15 mm in width and 50 mm in length cut out from the electrode film rolled web is peeled off by 90° at a speed of 20 mm/min after bonding a surface of the adhesive layer side of the test piece onto a center of a copper foil of 15 mm in width and 60 mm in length; An arithmetic mean value of measured values obtained by performing the same measurement three times is defined as the adhesive strength;
(Bonding Condition 1)
Roll bonding under an environment at a pressure of 8.6 kg/cm, a speed of 1 m/min, and 25° C.

4. The electrode film rolled web according to claim 3, wherein for a test piece thereof bonded under the following bonding condition 2, a heated adhesive strength in a 90° peeling test performed by the following measurement method is 0.10 N/cm or more:
(Measurement Method)
The strength is measured when a test piece of 15 mm in width and 50 mm in length cut out from the electrode film rolled web is peeled off by 90° at a speed of 20 mm/min after bonding a surface of the adhesive layer side of the test piece onto a center of a copper foil of 15 mm in width and 60 mm in length; An arithmetic mean value of measured values obtained by performing the same measurement three times is defined as the adhesive strength;
(Bonding Condition 2)
Roll bonding under an environment at a pressure of 8.6 kg/cm, a speed of 1 m/min, and 50° C.

5. The electrode film rolled web according to claim 1, wherein a SOC-OCV value determined by the following method is 18 times or more:
(Measurement Method)
An amount of the active material included in a test electrode prepared from the electrode film rolled web is calculated, and a theoretical capacity (mAh/g) of the test electrode is determined from a theoretical capacity of the active material and the amount of the active material; Then, with charging at 0.1 C for 30 minutes and pausing for 5 minutes as 1 time, the same operation is repeated 22 times in total for a coin cell for measurement; The number of times of charging until the voltage reaches 0.05 V is defined as an SOC-OCV value.

6. The electrode film rolled web according to claim 1, wherein the conductive material is flaky nickel particles.

7. The electrode film rolled web according to claim 1, wherein a release film is laminated on the adhesive layer.

8. An electrode comprising the electrode film rolled web according to claim 1 as a material.

9. An electrode laminate
wherein the electrode according to claim 8, and
any one selected from the group consisting of a current collecting foil, a separator, and a solid electrolyte membrane
are laminated.

10. An electrode laminate comprising:
the electrode according to claim 8;
a first member laminated on a first surface of the electrode; and
a second member laminated on a second surface of the electrode,
wherein each of the first member and the second member is any one selected from the group consisting of a current collecting foil, a separator, and a solid electrolyte membrane.

11. An electrochemical device comprising the electrode laminate according to claim 9.

12. An apparatus comprising the electrochemical device according to claim 11.
